(19) United States
(12) Patent Application Publication
(10) Pub. No.: US 2007/0130448 A1
(43) Pub. Date: Jun. 7, 2007

(54) Stack tracker

(75) Inventors: Stephan Jourdan, Portland, OR (US); Mark C. Davis, Portland, OR (US); Sebastien Hily, Hillsboro, OR (US)

Correspondence Address: CAVEN & AGHEVLI;c/o INTELLEVATE, P.O. BOX 52050, MINNEAPOLIS, MN, 55402, US

(73) Assignee: Intel Corporation

(21) Appl. No.: 11/291,378

(22) Filed: Dec. 1, 2005

(51) Int. Cl. G06F 9/30

(52) U.S. Cl. 712/218

(57) ABSTRACT

Methods and apparatus to identify memory communications are described. In one embodiment, an access to a stack pointer is monitored, e.g., to maintain a stack tracker structure. The information stored in the stack tracker structure may be utilized to generate a distance value corresponding to a relative distance between a load instruction and a previous store instruction.

### BACKGROUND

To improve performance, some processors utilize memory renaming (MRn). In particular, MRn permits the transformation of memory communication into register-register communication. Moreover, instructions which source data from loads predicted to rename may source data directly from the original producer without having to wait for the store to load memory communication.

A correct prediction may collapse the instruction dependency, providing performance benefits that extend beyond just avoiding the load latency associated with accessing a main memory outside of the processor. Hence, in some cases, a memory operation may be unnecessary as the original data that was stored to memory and immediately re-loaded from memory is still present in one of the registers of the processor. However, when a prediction is incorrect, the cost associated with recovering the processor state to a point prior to the misprediction can be costly, for example, in performance hits.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates a block diagram of portions of a processor core, according to an embodiment of the invention.

FIG. 2 illustrates a block diagram of an embodiment of a stack tracker structure.

FIG. 3 illustrates a flow diagram of an embodiment of a method to determine whether to memory rename an instruction.

FIGS. 4 and 5 illustrate block diagrams of computing systems in accordance with various embodiments of the invention.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, connections, and circuits have not been described in detail so as not to obscure the particular embodiments of the invention.

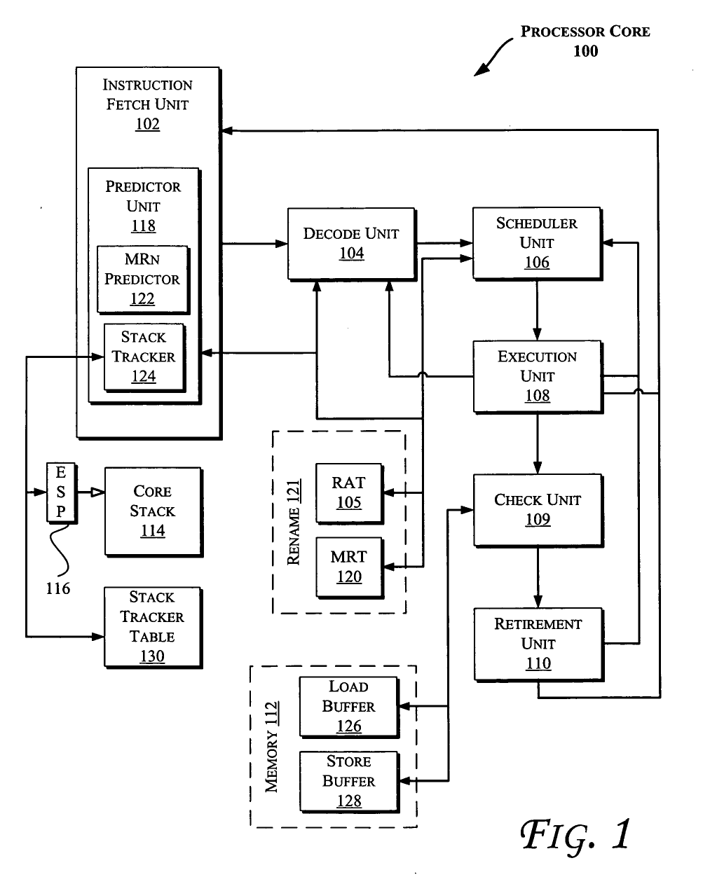

Techniques discussed herein with respect to various embodiments may be utilized to identify memory communications in one or more processing elements, such as the processor core shown in FIG. 1. Moreover, various embodiments (such as those discussed with reference to FIGS. 1-3) may be utilized to leverage static stack related program behavior to consistently track memory renaming operations, e.g., by limiting prediction inaccuracies. More particularly, FIG. 1 illustrates a block diagram of portions of a processor core 100, according to an embodiment of the invention. In one embodiment, the arrows shown in FIG. 1 indicate the direction of data flow. One or more processor cores (such as the processor core 100) may be implemented on a single integrated circuit chip (or die). Moreover, the chip may include one or more shared or private caches, interconnects, memory controllers, or the like.

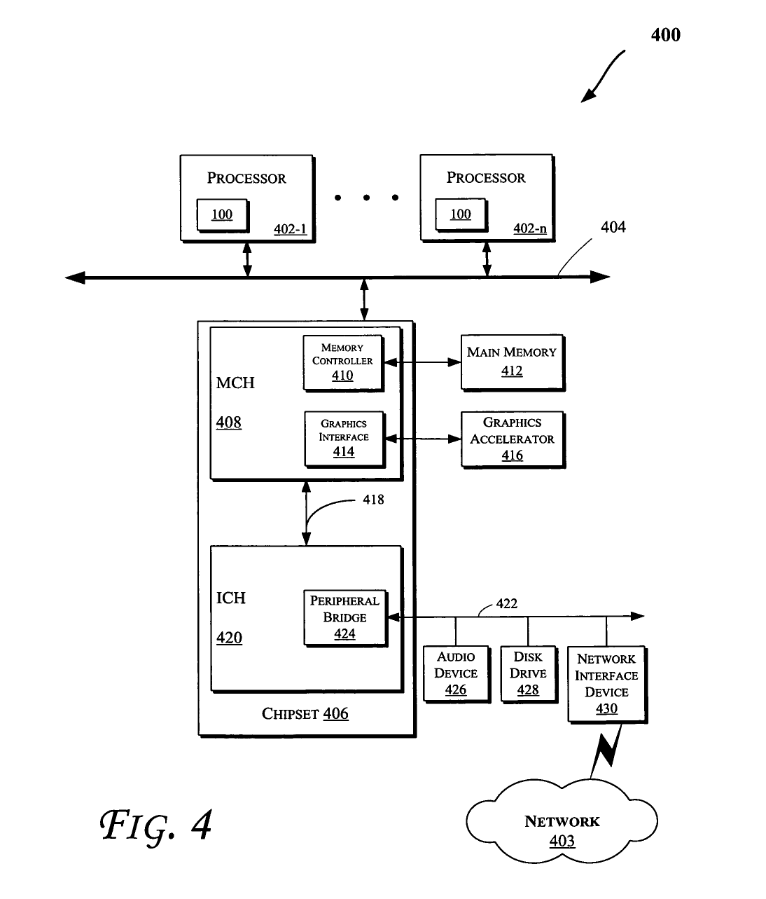

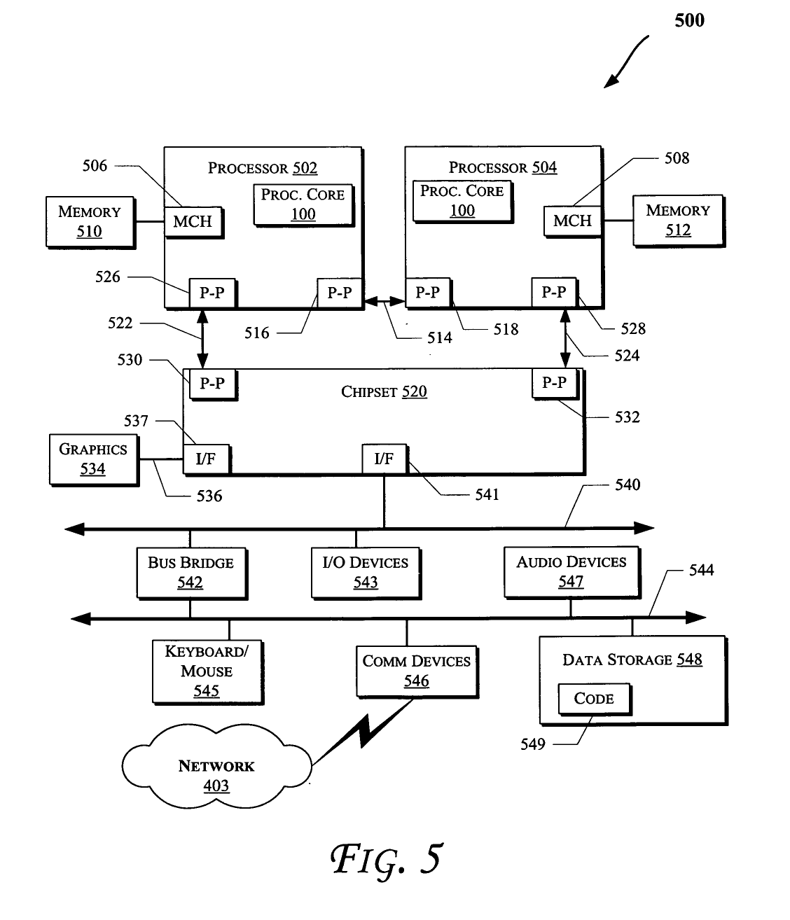

As illustrated in FIG. 1, the processor core 100 includes an instruction fetch unit 102 to fetch instructions for execution by the core 100. The instructions may be fetched from any storage devices such as the memory devices discussed with reference to FIGS. 4 and 5. The processor core 100 may include a decode unit 104 to decode the fetched instruction. For instance, the decode unit 104 may decode the fetched instruction into a plurality of uops (micro-operations). The decode unit 104 may communicate with a RAT (register alias table) 105 to maintain a mapping of logical (or architectural) registers (such as those identified by operands of software instructions) to corresponding physical registers. Hence, each entry in the RAT 105 may include a reorder buffer (ROB) identifier (ID) assigned to each physical register in an embodiment.

The processor core 100 may further include a scheduler unit 106. The scheduler unit 106 may store decoded instructions (e.g., received from the decode unit 104) until they are ready for dispatch, e.g., until all source values of a decoded instruction become available. For example, with respect to an “add” instruction, the “add” instruction may be decoded by the decode unit 104 and the scheduler unit 106 may store the decoded “add” instruction until the two values that are to be added become available. Hence, the scheduler unit 106 may schedule and/or issue (or dispatch) decoded instructions to various components of the processor core 100 for execution, such as an execution unit 108. The execution unit 108 may execute the dispatched instructions after they are decoded (e.g., by the decode unit 104) and dispatched (e.g., by the scheduler unit 106). In one embodiment, the execution unit 108 may include one or more execution units (not shown), such as a memory execution unit, an integer execution unit, a floating-point execution unit, or other execution units. Instructions executed may be checked by check unit 109 to assure that the instructions were executed correctly. A retirement unit 110 may retire executed instructions after they are committed. Retirement of the executed instructions may result in processor state being committed from the execution of the instructions, physical registers used by the instructions being de-allocated, etc.

As illustrated in FIG. 1, the retirement unit 110 may communicate with the scheduler unit 106 to provide data regarding committed instructions. Moreover, the execution unit 108 may communicate with the scheduler unit 106 to provide data regarding executed instructions, e.g., to facilitate dispatch of dependent instructions. As a result, the processor core 100 may be an out-of-order processor core in one embodiment. Also, the execution unit 108 may communicate with the instruction fetch unit 102, for example, to instruct the instruction fetch unit 102 to refetch an instruction when a branch misprediction or prediction violation occurs. In an embodiment, the check unit 109 may identify a load value misprediction (for example from memory disambiguation, memory renaming, or stack tracking such as discussed herein with reference to the remaining figures) and may notify the retirement unit 110 to reload the load and all instructions following the load pertaining to the misprediction from the instruction fetch unit 102.

In one embodiment, such as shown in FIG. 1, the processor core 100 may also include a memory 112 to store instructions and/or data that are utilized by one or more components of the processor core 100. To reduce obscuring the illustrated embodiment, all connections between the components of the processor core 100 are not shown in FIG. 1. However, various components of the processor core 100 may communicate with each other, as may be suggested by various operations discussed herein. Further, in one embodiment, the memory 112 may include one or more caches (that may be shared), such a level 1 (L1) cache, a level 2 (L2) cache, or the like (e.g., that may be external and/or internal to the processor core 100). For example, an instruction cache, or “I$” (not shown), may communicate with the instruction fetch unit 102 to store fetched instructions. Furthermore, various components of the processor core 100 may communicate with the memory 112 directly, through a bus, and/or memory controller or hub. In one embodiment, the RAT 105 may be stored in the scheduler unit 106.

The processor core 100 may further include a core stack 114 (also referred to as a “machine stack”) that provide last-in, first-out (LIFO) storage support to various components of the processor core 100. For example, the core stack 114 may be utilized to store data in response to push, pop, call, and/or return instructions, which may have parameter stack and control-flow stack behaviors. A stack pointer 116 (also referred to as an “ESP” or extended stack pointer) may point to the top of the core stack 114. The stack pointer 116 may be stored in any storage device such as a hardware register or a portion of the memory 112.

As shown in FIG. 1, the decode unit 104 and a predictor unit 118 may communicate with a memory rename table (MRT) 120 (which may also be stored in a rename unit 121 with the RAT 105, according to an embodiment). The MRT 120 may provide the name of the physical register associated with the source of a “store” instruction (whereas the RAT 105 may provide the destination registers in one embodiment). The predictor unit 118 may allow the scheduler unit 106 to replace memory communication with register-register communication. To this end, the predictor unit 118 may include a memory renamer (MRn) predictor 122 and/or a stack tracker 124. The stack tracker 124 may also be provided in any location within the processor core 100 (e.g., other than within the predictor unit 118). In one embodiment, the output of the predictor unit 118 may be provided by the stack tracker 124 and/or MRn predictor 122.

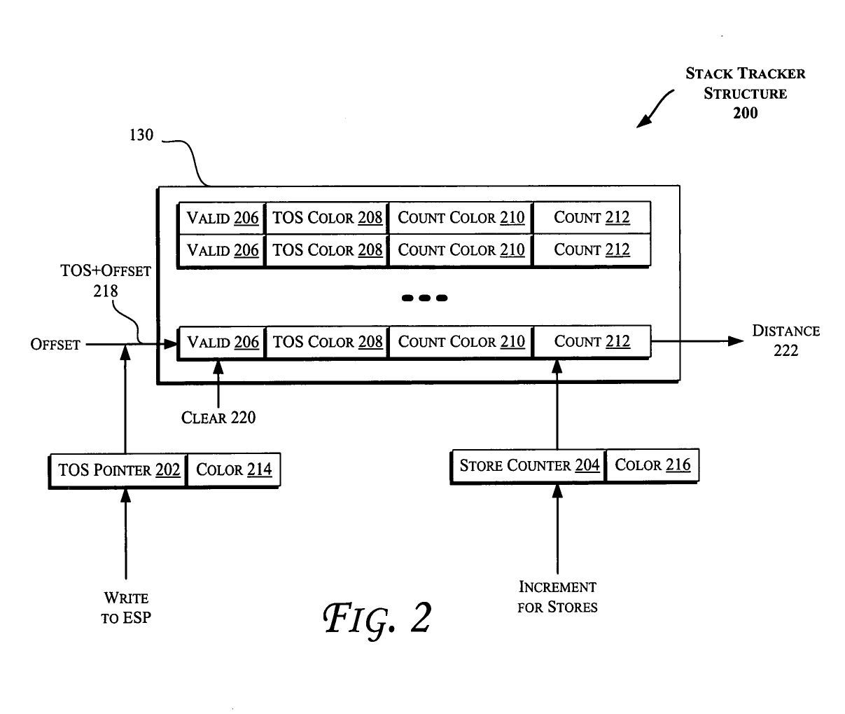

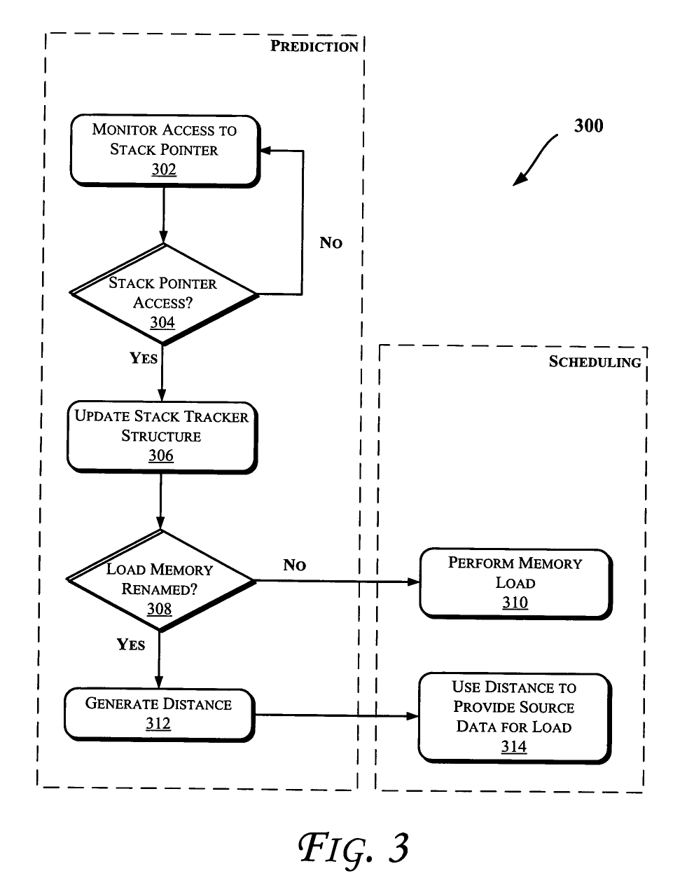

In an embodiment, the predictor unit 118 may determine if a fetched “load” instruction should be memory renamed (e.g., by the scheduler unit 106). If so, the MRn predictor 122 may generate a signal, such as a memory renamer enable signal to indicate to other components of the processor core 100 (e.g., the scheduler unit 106) that the load instruction should be memory renamed, as will be further discussed with reference to FIG. 3. The predictor unit 118 may then provide information to identify to which store register the load register should be memory renamed (e.g., a relative distance such as discussed with reference to FIG. 2). Moreover, when the register corresponding to the load instruction is allocated and renamed (e.g., by the scheduler unit 106), it may use information from the predictor unit 118 to access the MRT 120.

In one embodiment, the load instruction may cause generation of two other instructions. One of the instructions (e.g., “Mcheck” according to at least one instruction set architecture) may check that the prediction was correct (e.g., by the check unit 109). The other instruction (e.g., “Mrn_move” according to at least one instruction set architecture) may copy the value of the register provided by the MRT 120 into the load instruction's destination register (e.g., into the corresponding entry of the RAT 105). A load buffer 126 and a store buffer 128 may store pending memory operations that have not loaded or written back to a main memory (e.g., external to the processor core 100, such as memory 412 of FIG. 4), respectively.

In an embodiment, the check unit 109 may have access to the load buffer 126 and store buffer 128 (one or more of which may be stored in the memory 112 in an embodiment). The checking instruction (e.g., “Mcheck”) may read the original sources of the load instruction to compute an address and perform a disambiguation check against stores in the store buffer 128. The disambiguation may compare the actual load and predicted store addresses, which may be utilized to either validate the prediction or indicate a misprediction by triggering a pipeline reset (also referred to as a “nuke”) to clear the pipeline and/or refetch the respective load instruction (and instructions following the load instruction).

Additionally, the stack tracker 124 may communicate with a stack tracker table 130 (which may have 64 entries in one embodiment). The stack tracker 124 may include logic to monitor accesses (e.g., writes or reads) to the ESP 116 and perform some operations such as those discussed herein, e.g., with reference to FIG. 3. In an embodiment, the stack tracker table 130 may be stored in the memory 112. In one embodiment, the stack tracker 124 results are higher priority than the MRn predictor 122 results and will override them. Further details regarding the operation of the stack tracker 124 and the stack tracker table 130 will be discussed herein, for example, with reference to FIGS. 2-3. In one embodiment, the stack tracker table 130 may be provided within the instruction fetch unit 102 or decode unit 104.

FIG. 2 illustrates a block diagram of an embodiment of a stack tracker structure 200. In one embodiment, the arrows shown in FIG. 2 indicate the direction of data flow. The stack tracker structure 200 may include the stack tracker table 130, a top of stack pointer (TOS) 202, and a store counter 204. The TOS pointer 202 and store counter 204 may be implemented in storage devices such as hardware registers, memory locations (e.g., within the memory 112 of FIG. 1), or the like. The TOS pointer 202 and/or the store counter 204 may be implemented in the stack tracker 124 of FIG. 1, in an embodiment. Also, the stack tracker structure 200 shown in FIG. 2 may be provided inside the stack tracker 124, according to one embodiment.

Each entry of the stack tracker table 130 may include a valid field 206 (e.g., to indicate whether that entry includes valid data, which is 1 bit wide in an embodiment), a TOS color field 208, a count color field 210, and a count field 212. The count field 212 may store a count that may be utilized in determining the relative distance of a previous store instruction to the currently executing load instruction in the store buffer 128 of FIG. 1. For example, the value stored in the count field 212 may be provided by the store counter 204 when a store to ESP is executed. In one embodiment, the count field 212 may be 5 bits wide.

Furthermore, each of the TOS pointer 202 and store counter 204 may have a corresponding color field (e.g., 214 and 216, respectively). Each of the color fields (e.g., 208-210 and 214-216) may be 1 bit wide in an embodiment. In one embodiment, the stack tracker table 130 is a circular buffer and the color fields (e.g., 208-210 and 214-216) may be utilized to account for when a wrap in the circular buffer occurs. For example, when the TOS pointer 202 changes color, all entries sharing the same color bit as the TOS pointer color (214), may be cleared (e.g., by utilizing a clear signal (220) to clear the valid field 208 for all entries in the stack tracker table 130).

The operation of various components of FIGS. 1 and 2 will now be discussed with reference to FIG. 3. More specifically, FIG. 3 illustrates a flow diagram of an embodiment of a method 300 to determine whether to memory rename registers corresponding to an instruction. In an embodiment, the method 300 generates the distance value by utilizing the stack tracker structure 200 of FIG. 2 and the stack tracker 124 of FIG. 1. Hence, the operations of the method 300 may be performed by one or more components of a processor core, such as the components discussed with reference to FIGS. 1 and/or 2.

Referring to FIGS. 1-3, the stack tracker 124 may monitor (302) access to the stack pointer 116. If a stack pointer access occurs (304), at an operation 306, the stack tracker 124 updates one or more entries of the stack tracker structure 200. A stack pointer access (304) typically refers to one or more of a pop operation, a push operation, a call operation, or a return operation performed on the core stack 114, but could also include a load or a store to the ESP 116. Hence, the operations 302-306 may maintain the stack tracker structure 200.

The operation 306 may update various entries of the stack tracker structure 200. In one embodiment, the stack tracker 124 may increment the store counter 204 for each store operation seen by the processor core 100 (e.g., where the opcode of an instruction corresponds to a store instruction). For example, if the store counter 204 wraps to entry 0, in one embodiment with 64 total entries, entries 0 to 31 may be cleared (which share the same color). If the store counter 204 wraps to entry 32, in one embodiment with 64 total entries, entries 32 to 63 may be cleared (which share the same color). Also for each store operation to the core stack 114 (which accesses the stack pointer 116), the stack tracker 124 may write the value of the store counter 204 to the count field (212) of a corresponding entry of the stack tracker table 130. Generally, the stack tracker 124 indexes the stack tracker table 130 by a combination of the TOS pointer 202 and an offset of the load instruction (218). Additionally, at the operation 306, the stack tracker 124 may update the TOS pointer 202 for each write operation that writes an absolute address to the stack pointer 116, in part, because the write operation may change the top of stack location (e.g., as indicated by the TOS pointer 202).

At an operation 308, the predictor unit 118 may determine whether a load instruction that is fetched by the instruction fetch unit 102 is to have its registers memory renamed. If the load instruction is not to have its registers memory renamed, then the processor core 100 may perform a regular memory load (310), e.g., without memory renaming. Otherwise, at a operation 312, the predictor unit 118 may generate a signal indicative of a distance value (222) by subtracting the value stored in the count field (212) of a corresponding entry of the stack tracker table 130 (that has valid information as indicated by the valid field 206) from the value of the store counter 204. In one embodiment, the distance may represent the distance from an executing load to a previous store in store buffer identifiers (SBIDs). Hence, the distance value may be used to identify the store instruction by counting one or more SBIDs from an executing load instruction to a corresponding store instruction. In an embodiment, the method 300 may also determined whether the source data for the load instruction is to be forwarded from a previous store. As discussed with reference to the operation 306, the corresponding entry of the stack tracker table 130 may be indexed by the combination of the TOS pointer 202 and the offset provided by the load instruction (218). In one embodiment, operations 302, 304, 306, 308, and 312 may be performed at prediction time, e.g., by components of the instruction fetch unit 102.

At an operation 314, the scheduler unit 106 may utilize the distance value (222) to provide source data for the load instruction (e.g., by accessing the MRT 120). The distance value (222) may be generated such as discussed with reference to operation 312. Hence, the stack tracker 124, stack tracker table 130, and the stack tracker structure 200 may be utilized with a predictor (e.g., the predictor unit 118) and/or used for disambiguation by checking the prediction (e.g., provided by the MRn predictor 122) at the check unit 109. Moreover, disambiguation may be utilized for forwarding, e.g., where a store instruction is either predicted to forward to a load or is not predicted to forward to a load. In one embodiment, the prediction of the predictor unit 118 may be more efficient than a forwarding scheme because stores are not required to be serialized. In one embodiment, operations 310 and 314 may be performed at scheduling and utilized by the scheduler unit 106.

In an embodiment, the stack tracker 124 may flush a portion of the stack tracker table 130 when the store counter 204 wraps. Further, the stack tracker 124 may clear all entries of the stack tracker structure 200 upon the occurrence of one or more of the following: a nuke (instruction pipeline reset such as invoked by the retirement unit 110 upon a memory renaming misprediction or violation), a non-relative move to the ESP 116, a ring level change, reset (such as a processor core reset), a thread context switch (e.g., in multithreaded implementations that utilize the processor core 100), or a branch misprediction.

In various embodiments, the method 300 may be utilized where access to the stack pointer 116 maintains spill code or parameter passing. Generally, spill code may be generated in situations where all registers of a processor core (100) are overcommitted. In response, the generated spill code causes one or more registers to be vacated, so that program execution may proceed. Vacating a register typically entails storing its contents elsewhere (e.g., in the core stack 114) and later retrieving the stored content into available registers. Spill code is generally well behaved and could be handled with a stack (e.g., the core stack 114). In particular, spill code is well behaved because it pushes and then pops its parameters in LIFO order and models a stack closely. However, parameter passing is not well behaved—sometimes it may be out of order. Parameter passing generally occurs where one instruction passes a parameter to another instruction (e.g., through one or more subroutines by storing the parameter in the core stack 114). Hence, the techniques discussed with reference to FIGS. 1-3 may be utilized where access to the stack pointer 116 maintains spill code or parameter passing.

In an embodiment, the decode unit 104 may indicate whether an instruction is a push or pop operation to the core stack 114. To detect non-push/pop write accesses to the stack pointer 116, the stack tracker 124 may also read the destination operand, source operand, and immediate of all instructions, e.g., to track the TOS pointer 202 correctly. Moreover, the stack tracker 124 may take as input the bytes, immediate information of instructions, displacement information, osize (operand size), or other fields (such as modRM according to at least one instruction set architecture) for source and destination distinction.

FIG. 4 illustrates a block diagram of a computing system 400 in accordance with an embodiment of the invention. The computing system 400 may include one or more central processing unit(s) (CPUs) 402 or processors that communicate via an interconnection network (or bus) 404. The processors (402) may be any processor such as a general purpose processor, a network processor (that processes data communicated over a computer network 403), or the like (including a reduced instruction set computer (RISC) processor or a complex instruction set computer (CISC)). Moreover, the processors (402) may have a single or multiple core design. The processors (402) with a multiple core design may integrate different types of processor cores on the same integrated circuit (IC) die. Also, the processors (402) with a multiple core design may be implemented as symmetrical or asymmetrical multiprocessors. In an embodiment, one or more of the processors 402 may include one or more of the processor core(s) 100 of FIG. 1. Also, the operations discussed with reference to FIGS. 1-3 may be performed by one or more components of the system 400.

A chipset 406 may also communicate via the interconnection network 404. The chipset 406 may include a memory control hub (MCH) 408. The MCH 408 may include a memory controller 410 that is in communication with a memory 412. The memory 412 may store data and sequences of instructions that are executed by the CPU 402, or any other device included in the computing system 400. In one embodiment of the invention, the memory 412 may include one or more volatile storage (or memory) devices such as random access memory (RAM), dynamic RAM (DRAM), synchronous DRAM (SDRAM), static RAM (SRAM), or the like. Nonvolatile memory may also be utilized such as a hard disk. Additional devices may communicate via the interconnection network 404, such as multiple CPUs and/or multiple system memories.

The MCH 408 may also include a graphics interface 414 that is in communication with a graphics accelerator 416. In one embodiment of the invention, the graphics interface 414 may communicate with the graphics accelerator 416 via an accelerated graphics port (AGP). In an embodiment of the invention, a display (such as a flat panel display) may communicate with the graphics interface 414 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display.

A hub interface 418 may couple the MCH 408 to an input/output control hub (ICH) 420. The ICH 420 may provide an interface to I/O devices that are in communication with the computing system 400. The ICH 420 may communicate via a bus 422 through a peripheral bridge (or controller) 424, such as a peripheral component interconnect (PCI) bridge, a universal serial bus (USB) controller, or the like. The bridge 424 may provide a data path between the CPU 402 and peripheral devices. Other types of topologies may be utilized. Also, multiple buses may be in communication with the ICH 420, e.g., through multiple bridges or controllers. Moreover, other peripherals that communicate with the ICH 420 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), or the like.

The bus 422 may be in communication with an audio device 426, one or more disk drive(s) 428, and a network interface device 430 (which may be in communication with the computer network 403). Other devices may be in communication via the bus 422. Also, various components (such as the network interface device 430) may be in communication with the MCH 408 in some embodiments of the invention. In addition, the processor 402 and the MCH 408 may be combined to form a single chip. Furthermore, the graphics accelerator 416 may be included within the MCH 408 in other embodiments of the invention.

Furthermore, the computing system 400 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 428), a floppy disk, a compact disk ROM (CD-ROM), a digital versatile disk (DVD), flash memory, a magneto-optical disk, or other types of nonvolatile machine-readable media for storing electronic instructions and/or data.

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. The operations discussed with reference to FIGS. 1-3 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to couple with memories 510 and 512. The memories 510 and/or 512 may store various data such as those discussed with reference to the memories 112 and/or 412.

The processors 502 and 504 may be any processor such as those discussed with reference to the processors 402 of FIG. 4. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

At least one embodiment of the invention may be provided within the processors 502 and 504. For example, one or more of the processor core(s) 100 of FIG. 1 may be located within the processors 502 and 504. Other embodiments of the invention, however, may exist in other circuits, logic units, or devices within the system 500 of FIG. 5. Furthermore, other embodiments of the invention may be distributed throughout several circuits, logic units, or devices illustrated in FIG. 5.

The chipset 520 may communicate with a bus 540 using a PtP interface circuit 541. The bus 540 may communicate with one or more devices, such as a bus bridge 542 and I/O devices 543. Via a bus 544, the bus bridge 543 may communicate with other devices such as a keyboard/mouse 545, communication devices 546 (such as modems, network interface devices, or the like that may communicate with the computer network 403), audio I/O device, and/or a data storage device 548. The data storage device 548 may store code 549 that may be executed by the processors 502 and/or 504.

In various embodiments of the invention, the operations discussed herein, e.g., with reference to FIGS. 1-5, may be implemented as hardware (e.g., logic circuitry), software, firmware, or combinations thereof, which may be provided as a computer program product, e.g., including a machine-readable or computer-readable medium having stored thereon instructions (or software procedures) used to program a computer to perform a process discussed herein. The machine-readable medium may include any storage device such as those discussed with respect to FIGS. 1, 4, and 5.

Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a modem or network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. A method comprising:
monitoring an access to a stack pointer to update a stack tracker structure;
using information stored in the stack tracker structure to generate a distance value corresponding to a relative distance between a load instruction and a previous store instruction within a store buffer; and
using the distance value to provide source data for the load instruction.

2. The method of claim 1, further comprising updating one or more entries of the stack tracker structure in response to the access.

3. The method of claim 1, further comprising incrementing a store counter of the stack tracker structure for each store operation.

4. The method of claim 1, further comprising, for each store operation that accesses the stack pointer, writing a value of a store counter to a count field of a corresponding entry of a stack tracker table of the stack tracker structure.

5. The method of claim 1, further comprising, for each load operation that has a corresponding valid entry in a stack tracker table of the stack tracker structure, generating the distance value by subtracting a value stored in a count field of the corresponding entry of the stack tracker table from a value of a store counter.

6. The method of claim 1, further comprising utilizing the distance value to identify the store instruction by counting one or more store buffer identifiers from an executing load instruction to a corresponding store instruction.

7. The method of claim 1, further comprising determining whether the load instruction is to be memory renamed.

8. The method of claim 1, further comprising determining whether the source data for the load instruction is to be forwarded from a previous store.

9. An apparatus comprising:
a first logic to monitor an access to a stack pointer to update a stack tracker structure;
a second logic to generate a distance value signal corresponding to a relative distance between a load instruction and a previous store instruction within a store buffer based on information stored in the stack tracker structure; and
a third logic to provide source data for the load instruction based on information stored in the stack tracker structure.

10. The apparatus of claim 9, wherein a scheduler unit that schedules instructions for execution comprises the third logic.

11. The apparatus of claim 9, wherein a stack tracker comprises the first logic and the second logic.

12. The apparatus of claim 11, wherein a predictor unit that predicts whether to replace memory communication with register-register communication comprises the stack tracker.

13. The apparatus of claim 12, wherein an instruction fetch unit that fetches instructions for execution by a processor core comprises one or more of the stack tracker or the predictor unit.

14. The apparatus of claim 9, wherein the stack tracker structure comprises one or more of a stack tracker table, a top of stack pointer, a store counter, or one or more color fields.

15. The apparatus of claim 14, wherein the stack tracker table is a circular buffer.

16. The apparatus of claim 9, wherein the stack tracker table comprises a plurality of entries, each entry comprising one or more of a valid field, a top of stack color field, a count color field, or a count field.

17. The apparatus of claim 9, further comprising a core stack to which the stack pointer points.

18. The apparatus of claim 9, wherein the source data corresponds to a register value that fed a previous store instruction.

19. The apparatus of claim 9, wherein the store buffer stores results of a plurality of store instructions.

20. The apparatus of claim 9, further comprising a processor comprising a plurality of processor cores, each of the processor cores comprising one or more of the first logic, second logic, or third logic.

21. The apparatus of claim 9, wherein the third logic counts one or more store buffer identifiers from an executing load instruction to a corresponding store instruction.

22. A system comprising:
a memory to store a plurality of instructions; and
a processor core to execute the plurality of instructions, the processor core comprising:
a predicator unit to predict whether to replace memory communication with register-register communication based on information stored in a stack tracker structure; and
a stack tracker to update the stack tracker structure based on an access to a stack pointer.

23. The system of claim 22, wherein the predictor unit replaces memory communication with register-register communication for a load instruction that corresponds to a previous store instruction.

24. The system of claim 23, further comprising logic to provide source data for the load instruction based on information stored in the stack tracker structure.

25. The system of claim 22, wherein the stack tracker structure comprises one or more of a stack tracker table, a top of stack pointer, a store counter, or one or more color fields.

26. The system of claim 25, wherein the stack tracker table comprises a plurality of entries, each entry comprising one or more of a valid field, a top of stack color field, a count color field, or a count field.

27. The system of claim 22, further comprising a core stack to which the stack pointer points.

28. The system of claim 22, wherein the predictor unit counts one or more store buffer identifiers from an executing load instruction to a corresponding store instruction.

29. The system of claim 22, further comprising an audio device.

30. The system of claim 22, wherein the memory is one or more of a RAM, DRAM, or SDRAM.
